(19) United States
(12) Patent Application Publication
(10) Pub. No.: US 2004/0149807 A1
(43) Pub. Date: Aug. 5, 2004

(54) Method and apparatus for joining at least two work pieces by friction stir welding

(76) Inventors: Christoph Schilling, Kollow (DE); Alexander von Strombeck, Hamburg (DE); Jorg dos Santos, Loneburg (DE)

Correspondence Address: KLAUS J. BACH & ASSOCIATES, PATENTS AND TRADEMARKS, 4407 TWIN OAKS DRIVE, MURRYSVILLE, PA, 15668, US

(21) Appl. No.: 10/762,050

(22) Filed: Jan. 16, 2004

(30) Foreign Application Priority Data
Jan. 30, 2003 (DE) 103 03 623.7

(51) Int. Cl. B23K 20/12

(52) U.S. Cl. 228/112.1; 228/2.1

(57) ABSTRACT

In a method and apparatus for joining at least two work pieces by friction stir welding wherein the work pieces are at least partially plasticized in the area where they are to be joined by a rotating friction tool provided with a projection which can be moved into the area of the joint to be formed, the projection on the rotating tool has a length corresponding about to the thickness of the work piece and a shoulder around the pin-like projection so that, upon movement of the tool toward the work pieces, the work piece material is plasticized by the rotating pin-like projection which moves into the work piece material until it reaches the surfaces of the lowermost

### BACKGROUND OF THE INVENTION

The invention resides in a method and apparatus for joining at least two work pieces by friction stir welding wherein the work pieces are at least partially plasticized in the area of the joint by a rotating friction member having a pin projecting into the joint area. The invention also resides in an apparatus for performing such a method.

A similar method and similar apparatus are known from EP-B-0615480. Basically friction welding has been known for some years. Originally for friction welding two work pieces which were to be joined by friction welding were moved relative to each other in the joint area while being engaged with each other by a predetermined force. The friction generated heat by which the work pieces were plasticized in the joint area. Upon sufficient plastification, the work piece materials intermix in the interface area so that, upon cooling, the desired weld joint between the two work pieces is formed.

With friction stir welding, a pin-like projection is rotated by a drive or motor at high speed and is moved between the almost abutting faces of two work pieces to be joined. The pin-like projection is guided by a special guide apparatus or a robot and is moved thereby along the interface area between the two work pieces to be joined. Upon sufficient plastification of the adjacent work piece material areas, the pin-like projection is moved further along the interface area between the two work pieces so that a longitudinal welding seam is formed for example.

Also, other welding methods are known for example in automotive or aeronautical engineering for joining components of light metals with components of steel. Mechanical jointing procedures and cementing techniques are used in this connection for forming a spot-like or axial connection between a work piece of light metal and a work piece of steel. Friction weld joints of this material combination are performed with structural components generally only in the form of bolt friction welds. The friction weld processes used up to now are not suitable to join materials over an extended section in a material-interlocking manner. Therefore, work pieces which have been joined by friction welding do not have the strength required for many joints.

The use of work pieces of aluminum or aluminum alloys which are being used more extensively in the construction of airplanes and also motor vehicles, is problematic as far as weld joints between such different work pieces are concerned. The reason is that aluminum and aluminum alloys form with the oxygen of the ambient air a very objectionable oxide layer on the surface areas which causes a substantial electrical resistance between the components being joined and which also causes the oxide to enter the plasticized area of the work pieces. Consequently, impurities of aluminum oxides are embedded in the plasticized area of the work pieces joined. In addition, inter-metallic phases develop since the work pieces have different melting and solidification points.

It is consequently the object of the present invention to provide a method and apparatus by which metallic and also non-metallic work pieces can be joined in a simple and secure manner without the need for additional connecting elements. The joints should be highly precise and reproducible, they should be gas tight and they should be easy to make so that the method and apparatus can be used in connection with manufacturing robots.

### SUMMARY OF THE INVENTION

In a method and apparatus for joining at least two work pieces by friction stir welding wherein the work pieces are at least partially plasticized in the area where they are to be joined by a rotating friction tool provided with a projection which can be moved into the area of the joint to be formed, the projection on the rotating tool has a length corresponding about to the thickness of the work piece and a shoulder around the pin-like projection so that, upon movement of the tool toward the work pieces, the work piece material is plasticized by the rotating pin-like projection which moves into the work piece material until it reaches the surfaces of the lowermost work piece while compressing the plasticized material.

The invention is based on the fact that, with friction stir welding, joints between various types of material can be established. Because of the different melting points of the materials of which the work pieces consist, the work pieces cannot be joined by normal melt welding methods. With the present invention, the work pieces can be firmly joined over any desired length. Another advantage of the method is that, in contrast to the various welding methods, the connecting areas of the work pieces to be joined do not need to be prepared or pretreated. In addition, no material has to be added. Since the pin-like projection extends from the top only to the surface of a lower work piece, a metallic clean surface for example of a steel work piece is obtained with a continuously rotating projection. As a result, a gas-tight material-bridging connection of the adjacent work pieces which are being joined is obtained.

Advantageously, a lower work piece is joined with at least one work piece disposed on top of the lower work piece in a material-interlocking manner such that the joint has a certain high strength. Because of the rotation of the projection, the surface of the lower work piece is roughened so that the materials of the two work pieces are intermixed at the interface and a firm local connection between for example an aluminum work piece and a steel work piece is obtained.

In addition, it is made sure with the use of a friction welding tool that, expediently, oxides and oxide-containing compounds are removed from the surfaces of the lower work piece and also of the upper work piece so that the jointure between the work pieces of different materials to be joined is improved. In addition, the electrical resistance at the interface is reduced. However, the surface areas of the upper work piece may of course also be cleaned.

Upon movement of the pin-like projection along an interface area of two work pieces the work pieces can be joined durably and firmly over an extended section. During the stir welding procedure, the pin-like projection and the weld area may also be moved relative to each other, wherein the pin-like projection may be moved relative to the work pieces or the work pieces may be moved relative to the pin-like projection.

The interconnection of the work pieces can be improved in that a pressure is applied to the material to being plasticized so that, after cooling of the material, the lower work piece is joined to the upper work piece.

In a particular embodiment of the invention, the pressure is generated by means of a shoulder of the pin-like projection.

The strength of the connection between the work pieces is further increased if, at the same time, the work pieces are joined in a form-locking manner. Then not only the weld joint as such forms the connection but the additional form-locking contributes to the strength of the connection. In this case, the geometry of the work pieces is taken into consideration for joining the work pieces.

The form-locking connection is achieved particularly by the introduction of the material being plasticized into at least one recess of the lower work piece.

In the apparatus for interconnecting at least two adjacent work pieces by friction stir welding, the pin-like projection is movable essentially along its axis of rotation through the material being plasticized of a work piece at least up to the surface of the work piece disposed below. In accordance with the invention, the apparatus is so designed that the pin-like projection does not extend through all the work pieces to be joined. Rather, the insertion depth of the pin-like projection is so selected or adjusted that the pin-like projection passes fully at least through one of the work pieces but only touches the surface of the lowermost work piece. The advantages of such an arrangement have been pointed out in connection with the description of the method according to the invention.

Advantageously, the length of the pin-like projection corresponds essentially to the thickness of the work piece or work pieces disposed on top of the lowermost work piece. In this way, it is ensured that the pin-like projection does not enter the lowermost work piece.

In order to provide for a good connection with the lower-most work piece into which the pin-like projection did not enter, the pin-like projection extends preferably from a shoulder by way of which a pressure can be applied to the plasticized material.

The pin-like projection and/or the shoulder may be provided with a wear layer so that the apparatus provides a reliable connection between the work pieces. The wear layer may consist of diamonds or another hard material in order to improve the live and operation of the apparatus.

Below an embodiment of the invention will be described in greater detail on the basis of the accompanying schematic drawings.

### BRIEF DESCRIPTION OF THE DRAWINGS

FIG. 1a-FIG. 1c show schematically the method steps for the joining of two work pieces and

FIG. 2 is a schematic cross-sectional view of a joint.

### DESCRIPTION OF A PARTICULAR EMBODIMENT

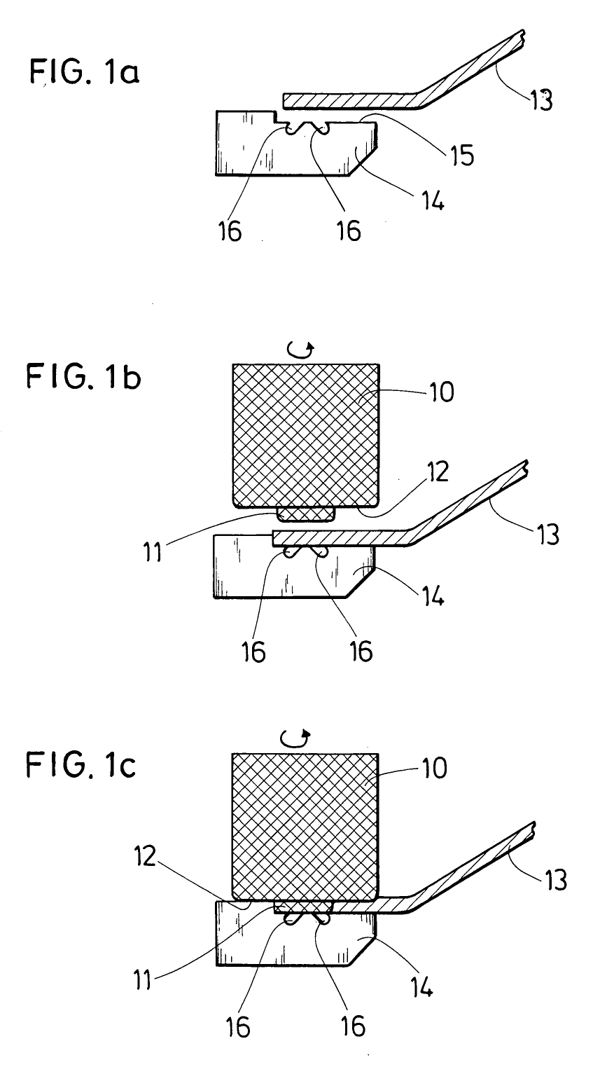

FIGS. 1a-1c show schematically the method steps for forming a joint between two work pieces 13, 14, which are shown in cross-section. The work piece 13 is arranged in a recess 15 cut into the work piece 14. In the recess 15 grooves 16 are cut into the work piece 14 (FIG. 1a).

When the work piece 13 is placed on the work piece 14 in the recess 15, a friction welding tool 10 is moved in from one side of the work piece 13. At its operating end, the tool has a projection 11 projecting from a shoulder 12 of the tool 10 (FIG. 1b).

The tool 10 is pressed axially against the work piece 13 and is rotated so that between the tool 10 or, respectively, the projection 11 thereof, friction heat is generated which locally plasticizes the adjacent material of the work piece 13 permitting the projection 11 to advance into and through the work piece 13. When the projection 11 of the tool 10 has advanced through the work piece 13, it comes into contact with the surface of the work piece 14. When the welding tool 16 has locally plasticized the work piece 13 (for example of aluminum), as a result of the pressure applied to the tool, the plasticized material is pressed by the shoulders 13 into the grooves 16 (FIG. 16). The shoulder 12 of the tool 10 generates, because of the axial force applied thereto, a pressure in the plasticized material of the work piece 13. Then the welding tool 10 is moved along a predetermined connecting area.

By the friction of the projection 10 on the surface of the recess 15 on which the work piece is disposed, any oxides are removed from the surface of the recess 15, so that a gas-tight joint can be formed between the work pieces 13 and 14. Under the pressure applied to the tool 10 during the stir friction welding material plasticized thereby will flow into the grooves 16 to generate also a form-locking connection between the work pieces 13 and 14 which increases the strength of the joint.

It has been found that this procedure is very suitable for joining work pieces of light metal and steel since a stable joint of high strength can be provided in a simple manner.

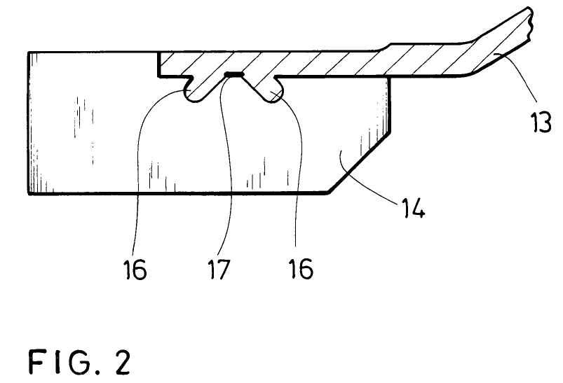

FIG. 2 is a cross-sectional view of a joint between the work pieces 13 and 14 formed in accordance with the present invention. With the introduction of the plasticized material into the grooves 16 a form-locking connection between the work pieces 13 and 14 is achieved. In addition, in the area of the web 17 between the two grooves 16, the materials of the two work pieces 13, 14 are alloyed together.

What is claimed is:

1. A method for joining at least two work pieces (13, 14) by friction stir welding using a rotating tool (10) with a pin-like projection (11); comprising the steps of:
placing said at least two work pieces (13, 14) on top of one another such that the areas to be joined are disposed adjacent one another, moving said rotating tool 10 onto the uppermost work piece (13) in the area where the work pieces are to be joined such that said pin-like projection (11) engages said work pieces and, while being pressed against said work piece, generates friction heat to at least plasticize the material of said work piece (13), moving said rotating tool (10) axially toward the lowermost work piece through the material being plasticized up to the top surface of the lowermost work piece (14) and then removing said rotating tool (10).

2. A method according to claim 1, wherein an alloyed joint is formed between the work pieces by the plasticized materials which were intermixed during the friction stir welding.

3. A method according to claim 1, wherein oxides are removed from the surfaces of the work pieces as the pin-like projection (11) frictionally engages the surfaces of the work pieces.

4. A method according to claim 1, wherein the tool (10) with the pin-like projection (11) is moved along the joint area.

5. A method according to claim 1, wherein pressure is applied to the material while being plasticized.

6. A method according to claim 5, wherein the pressure is applied by a shoulder (12) of the tool (10) around the pin-like projection (11).

7. A method according to claim 1, wherein the work pieces (13, 14) are joined also in a form-locking manner.

8. A method according to claim 7, wherein said work pieces (13, 14) are joined in a form-locking manner by the introduction of plasticized material into cavities (16) formed into the lower work piece (14).

9. An apparatus for joining at least two work pieces (13, 14) by friction stir welding, which work pieces (13, 14) are disposed closely adjacent each other in the area in which they are to be joined, said apparatus comprising:
a rotatable shaft (10) having a free end with a pin-like projection (11), which, for stir welding, is brought into contact with the area in which the work pieces (13, 14) are to be joined for plasticizing the joint area, said pin-like projection being movable along its axis of rotation through the material of the work pieces, while plasticizing the work piece materials by friction heat until the pin-like projection (11) reaches the surface of the lowermost work piece (14).

10. An apparatus according to claim 9, wherein the length of said projection (11) corresponds essentially to the thickness of the work piece or work pieces on top of the lowermost work piece (14).

11. An apparatus according to claim 9, wherein said pin-like projection (11) is disposed on a shoulder (12) of said rotatable shaft (10).

12. An apparatus according to claim 19, wherein at least one of said shoulder (12) and said pin-like projection (11) is provided with a wear layer.
